(19) United States
(12) Patent Application Publication
(10) Pub. No.: US 2025/0269871 A1
(43) Pub. Date: Aug. 28, 2025

(54) EYES-OFF-ROAD DRIVING ASSISTANCE SYSTEM

(71) Applicant: Zeljko Medenica, Birmingham, MI (US)

(72) Inventor: Zeljko Medenica, Birmingham, MI (US)

(21) Appl. No.: 18/590,921

(22) Filed: Feb. 28, 2024

(51) Int. Cl. B60W 60/00; B60W 50/14

(52) U.S. Cl. CPC B60W 60/001; B60W 50/14; B60W 2050/146; B60W 2540/225; B60W 2540/229; B60W 2552/20; B60W 2555/20

(57) ABSTRACT

An eyes-off-road driving assistance system for autonomous driving vehicle. The system includes a static eyes-off-road time module and a dynamic eyes-off-road factor process module. The static eyes-off-road time module determines an initial eyes-off-road time for the driver based on various static condition of the driver's eye gaze conditions detected by a driver monitor system. The dynamic eyes-off-road factor process module acquires and evaluates sundry dynamic eyes-off-road factors acquired from traffic, road, environment, vehicle and driver conditions and determines a time factor to further modify a static eyes-off-road time and to provide the final allowed eyes-off-road time for the driver during autonomous driving.

### FIELD

The present invention relates to vehicle technology, and more specifically to autonomous driving vehicle technology.

### BACKGROUND

The background description provided herein is for the purpose of generally presenting the context of the disclosure. Work of the presently named inventors, to the extent it is described in this background section, as well as aspects of the description that may not otherwise qualify as prior art at the time of filing, are neither expressly nor impliedly admitted as prior art against the present disclosure.

As the autonomous driving and advanced driving assistance systems become more advanced and commonplace in modern vehicles, it is becoming a common practice among vehicle manufacturers to employ a driver monitor using eye-trackers to monitor the state of the driver in order to determine if the drivers are paying attention to the road. This is necessary since these state-of-the-art autonomous driving systems are still not completely reliable and driver's attention is necessary in order to perform a transfer of control from the autonomous driving mode to manual driving mode when deemed necessary by the autonomous driving control system.

Furthermore, the driver monitor system (DMS) is needed to prevent drivers from abusing the capabilities of the autonomous driving system. The current state-of-the-art is to allow drivers to look away from the road for a predetermined time duration. Using an eye-tracker the autonomous driving system in the vehicle can determine how long a driver is looking away from the road and based on that issue a warning or a take-over request.

While the state-of-the-art driver monitor system providing assurance of driver's eyes-off-road time not to exceed a predetermined allowed duration of time and it does provide safety feature to the autonomous driving vehicle operation, it can nevertheless be further enhanced to improve driver's experience in two aspects.

Therefore, in one aspect, it is the purpose of this invention to enhance the driving experience of the autonomous driving safety feature by further examining the various factors affecting the operation of the autonomous vehicle and make necessary reduction of the allowed period of time that the driver may take the eyes off the road. This will further enhance the driver's safety experience.

It is also the purpose of this invention to enhance the driving experience of the autonomous driving comfort and convenience feature by extension of the allowed eyes-off-road time when the driving conditions are so favorable that all the various eyes-off-road factors influencing the driver's eyes-off-road time are deemed appropriate to extend the driver's eyes-off-road time. This will further enhance the driver's comfort and convenience experience.

Advantageously, the eyes-off-road driving assistance system according to the present invention will enhance the driving experience in safety feature of autonomous driving.

Advantageously, the eyes-off-road driving assistance system according to the present invention will also enhance the driving experience in comfort and convenience feature of autonomous driving.

### SUMMARY

An eyes-off-road driving assistance system for autonomous driving is disclosed. The system determines an eyes-off-road time for the driver in an autonomous or semi-autonomous vehicle which is equipped with a sensor system for sensing the driving environment, a driver monitor system providing driver eye-gaze information, a driver warning system providing warning signals to the driver and a human-machine interface (HMI) system which includes an eyes-off-road time monitor.

The eyes-off-road driving assistance system includes a static eyes-off-road time module and a dynamic eyes-off-road factor process module. The static eyes-off-road time module generates a static eyes-off-road time allowance for the driver allowing driver's eye gaze to be away from the road in front of the autonomous driving vehicle, and the dynamic eyes-off-road factor process module generates a dynamic eyes-off-road adjustment factor to be used for adjusting the allowed static eyes-off-road time preliminarily determined by the static eyes-off-road time module.

The eyes-off-road driving assistance system also includes an eyes-off-road time adjustment module which makes adjustment on the static eyes-off-road time allowance for the driver based on the dynamic eyes-off-road adjustment factor and generates a final allowed eyes-off-road time for the driver according to the present invention. The adjustment of the eyes-off-road time may be performed by multiplying the adjustment factor to the static eyes-off-road time or by adding or subtracting a time period from the allowed static eyes-off-road time or any other compatible mathematical principles.

The static eyes-off-road time may be determined based on driver's eye-gaze location. The static eyes-off-road time may also be determined based on driver's eye-gaze direction.

The dynamic eyes-off-road factor process module analyzes states of the various dynamic factors acquired from the HMI module, and determines the assessment based on the state of a particular factor. The assessments of the various factors are processed to form a single consolidated dynamic eyes-off-road time adjustment factor. The initial static eyes-off-road time is then adjusted by this dynamic eyes-off-road time adjustment factor.

The various dynamic factors may include, but not limited to traffic factor, road factor, environmental factor, vehicle factor and driver factor. The traffic factor evaluates the traffic flow condition during the autonomous driving, the road factor evaluates the road geometric condition over the autonomous driving path, the environmental factor evaluates the weather conditions during the autonomous driving time, the vehicle factor evaluates the vehicle operating conditions and the driver factor evaluates the driver's condition of alertness.

The dynamic eyes-off-road time adjustment factor generated by the dynamic eyes-off-road factor process module may be a unitless scaler to be multiplied to the preliminarily determined static eyes-off-road time. The dynamic eyes-off-road time adjustment factor generated by the dynamic eyes-off-road factor process module may also be a time period to be added or subtracted from the preliminarily determined static eyes-off-road time.

Further areas of applicability of the present disclosure will become apparent from the detailed description provided hereinafter. It should be understood that the detailed description and specific examples are intended for purposes of illustration only and are not intended to limit the scope of the disclosure.

### BRIEF DESCRIPTION OF THE DRAWINGS

The present disclosure will become more fully understood from the detailed description and the accompanying drawings, wherein:

FIG. 1 illustrates an autonomous vehicle with eyes-off-road driving assistance system according to the present invention;

FIG. 2 shows a block diagram of the eyes-off-road driving assistance system;

FIG. 3 illustrates one mode of operating the static eyes-off-road time module and the principle of operating the same;

FIG. 4 illustrates another mode of operating the static eyes-off-road time module and the principle of operating the same;

FIG. 5 shows a block diagram of the dynamic eyes-off-road factor process module of the present invention;

FIG. 6A, FIG. 6B, FIG. 6C, FIG. 6D and FIG. 6E illustrate the various modes of operating the dynamic eyes-off-road factor process module and the principle of operating the same; and

FIG. 7 illustrates a flow diagram of operating the eyes-off-road driving assistance system according to the present invention.

### DETAILED DESCRIPTION

The following description is merely exemplary in nature and is in no way intended to limit the disclosure, its application, or uses. For purposes of clarity, the same reference numbers with or without a single or multiple prime symbols appended thereto will be used in the drawings to identify similar elements. Likewise, the same reference numbers appended with a number after a hyphen will also be used in the drawings to identify similar elements. It should be understood that steps within a method may be executed in different order without altering the principles of the present disclosure unless otherwise specified.

As used herein, the term module may refer to an application specific integrated circuit, an electronic circuit, a processor (shared, dedicated, or group) and memory that execute one or more software or firmware programs, a combinational logic circuit, and/or other suitable components that provide the described functionality.

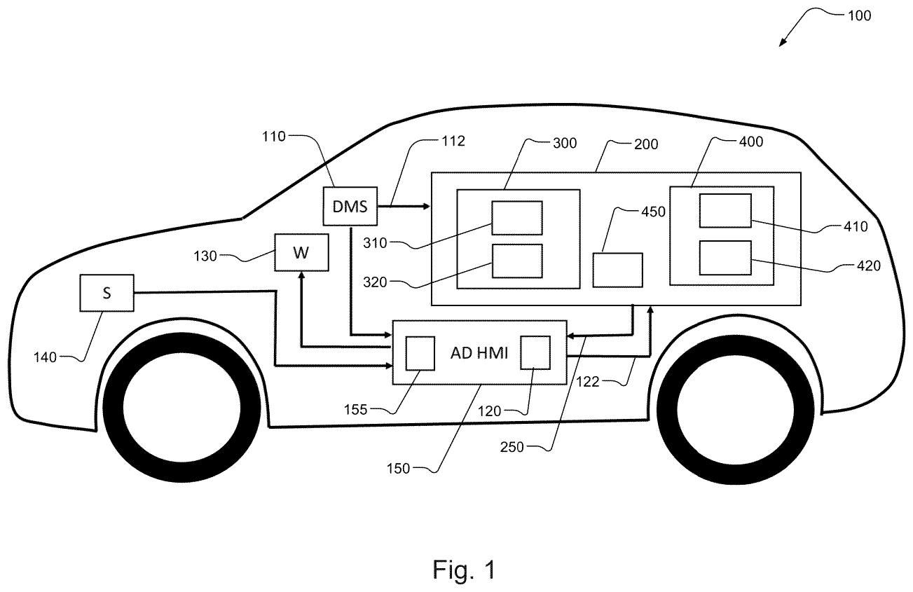

Referring now to FIG. 1, an autonomous driving vehicle equipped with an eyes-off-road driving assistance system (200) is shown. The vehicle is also equipped with a driver monitor system (DMS) (110), a sensor system (140), a driver warning system (130) and an autonomous driving human-machine interface (HMI) system (150) to work collaboratively with the eyes-off-road driving assistance system (200) directly or indirectly. The autonomous driving HMI system (150) also includes a dynamic factor acquisition module (120) and an eyes-off-road time monitor (155).

The eyes-off-road driving assistance system (200) includes a dynamic eyes-off-road factor process module (300) and a static eyes-off-road time module (400) and processes the various types of information relevant to the eyes-off-road time determination. The dynamic eyes-off-road factor process module (300) further includes a dynamic eyes-off-road factor analysis module (310) and a dynamic eyes-off-road factors consolidation module (320). These modules evaluate the various dynamic criteria relevant to driver's eyes-off-road time and determine a dynamic factor to enhance the eyes-off-road feature of autonomous driving.

The static eyes-off-road time module (400) further includes an eye-gaze recognition module (410) and a static eyes-off-road time assessment module (420). The eyes-off-road driving assistance system (200) also includes a eyes-off-road time adjustment module (450) which operates collaboratively with the dynamic eyes-off-road factor process module (300) and the static eyes-off-road time module (400) to determine an allowed eyes-off-road time for the driver. The interaction and collaboration among these modules within the autonomous driving vehicle will be made clear further in this disclosure.

The driver monitor system (DMS) (110) is in electrical communication with the eyes-off-road driving assistance system (200) and sends an eye-gaze information (112) to the eyes-off-road driving assistance system (200). The eyes-off-road driving assistance system (200) is also in electrical communication with the autonomous driving HMI system (150). The eyes-off-road driving assistance system (200) sends an allowed eyes-off-road time for driver (250) to the autonomous driving HMI system (150) and receives a dynamic factor information (122) from the autonomous driving HMI system (150).

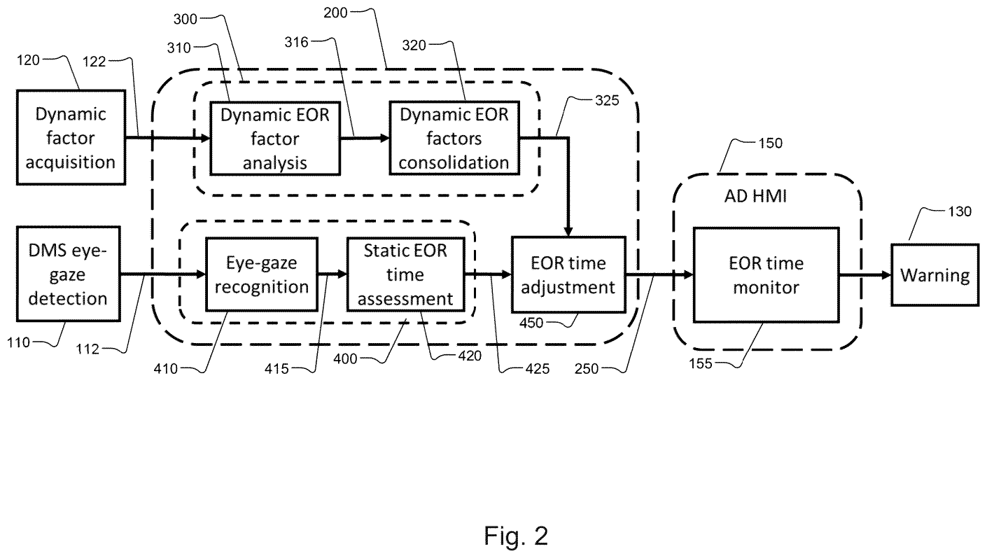

Referring now to FIG. 2, a block diagram illustrating the operation of the eyes-off-road driving assistance system (200) with the autonomous driving vehicle system is shown. The eyes-off-road driving assistance system (200) receives a dynamic factor information (122) from the dynamic factor acquisition module (120) via electrical communication. The eyes-off-road driving assistance system (200) also receives an eye-gaze information (112) from the driver monitor system (DMS) (110) via electrical communication. The eyes-off-road driving assistance system (200) sends an allowed eyes-off-road time for driver (250) to the eyes-off-road time monitor (155) of the autonomous driving HMI system (150) via electrical communication. The eyes-off-road time monitor (155) monitors the driver's eyes-off-road time and sends warning to the driver warning system (130) based on a comparison between the received information of allowed eyes-off-road time for driver (250) and driver's actual eyes-off-road time.

During an autonomous driving operation, drivers are permitted to have the eyes taken off the road in front of the vehicle for desired comfort and convenience. However, such comfort and convenience feature faces challenges from the driving safety consideration. These challenges are resolved with an optimal solution provided by the present invention via a systematic handling of the various static and dynamic issues with respect to the driver's eyes-off-road time. It is the operation of the eyes-off-road driving assistance system (200) that results in such optimal balance between the safety feature and the comfort and convenience feature of autonomous driving.

The operation of the eyes-off-road driving assistance system (200) is described below. The eyes-off-road driving assistance system (200) includes a static eyes-off-road time module (400) which processes the static aspect of driver eyes-off-road time matters. The eyes-off-road driving assistance system (200) also includes a dynamic eyes-off-road factor process module (300) which processes the dynamic aspect of the driver eyes-off-road time matters.

The static eyes-off-road time module (400) includes an eye-gaze recognition module (410) and a static eyes-off-road time assessment module (420). The eye-gaze recognition module (410) determines and sends a recognized eye-gaze characteristic (415) to the static eyes-off-road time module (400) via electrical communication. The static eyes-off-road time assessment module (420) generates a static eyes-off-road time allowance (425) which preliminarily determines an eyes-off-road time permitted for the driver.

The dynamic eyes-off-road factor process module (300) includes a dynamic eyes-off-road factor analysis module (310) and a dynamic eyes-off-road factors consolidation module (320). The dynamic eyes-off-road factor analysis module (310) generates a dynamic eyes-off-road time factor assessment (316) and sends the dynamic eyes-off-road time factor assessment (316) to the dynamic eyes-off-road factors consolidation module (320) via electrical communication. The dynamic eyes-off-road factors consolidation module (320) generates a dynamic eyes-off-road time adjustment factor (325) which will be used to further modify the preliminary eyes-off-road time allowance generated by the static eyes-off-road time assessment module (420) in a later-stage process.

The eyes-off-road time adjustment module (450) receives the static eyes-off-road time allowance (425) from the static eyes-off-road time module (400) and the dynamic eyes-off-road time adjustment factor (325) from the dynamic eyes-off-road factor process module (300) via electrical communication. In eyes-off-road time adjustment module (450) the static eyes-off-road time allowance (425) is further modified based on the information of dynamic eyes-off-road time adjustment factor (325). The modification may take various forms based on the form of the dynamic eyes-off-road time adjustment factor (325) with application of various types of appropriate mathematical principles. For example, the modification may be carried out by using multiplication of scaler number, or by using addition or subtraction of incremental duration of time. The modification may also be carried out by machine learning, statistical analysis or certain optimization process. Exemplary embodiments of the eyes-off-road time adjustment module (450) will be described in a later paragraph of this disclosure.

The operation of the static eyes-off-road time module (400) is further described in the following paragraphs. The idea here is to adjust the allowed eyes-off-road time based on the location where a driver is looking at inside the vehicle. In this situation, a longer eyes-off-road time can be allowed if the driver is looking at predefined locations inside the vehicle, whereas shorter times are used for glances directed at non-predefined locations.

For instance, if the eye-gaze recognition module (410), based on an eye-gaze information (112) from the driver monitor system (DMS) (110), detects that a driver is looking at any of the HMI displays inside the vehicle cabin, such as a central cluster display or instrument cluster display or a device the driver brought into the car that can be connected to the vehicle, a longer eyes-off-road time can be allowed. This way the vehicle can present a warning or any kind of message directly to that screen in order to capture driver's attention when needed.

Furthermore, the location of the in-cabin HMI display can also play a role in determining the allowed eyes-off-road time: those HMI displays that are located closer to the forward road may translate into a longer allowed eyes-off-road time; on the other hand, those HMI displays that are located further away from the forward road translate into a shorter allowed eyes-off-road time.

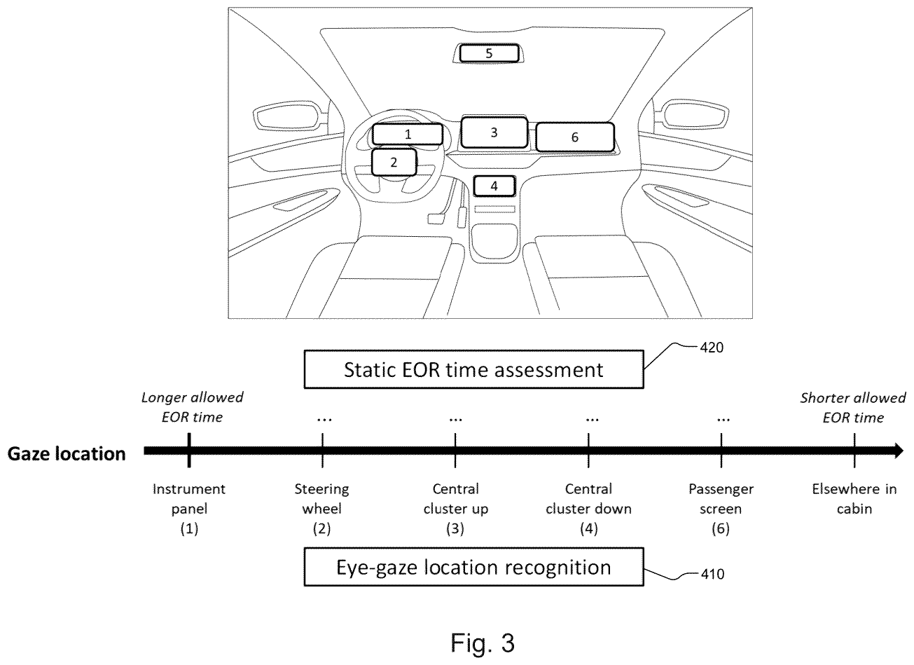

Referring now to FIG. 3, an illustration is shown providing an example how the allowed eyes-off-road time may be adjusted based on the predefined location where the driver is looking at inside the cabin. In this example, the eye-gaze recognition module (410) analyzes the driver's eye-gaze information (112) and resolves the precise eye-gaze location.

The eye-gaze recognition module (410) determines that the driver's eye gaze is focused on a certain location. This location may be the instrument panel, i.e., the location no. 1, or the steering wheel, i.e., location no. 2, or the central cluster up location, i.e., location no. 3, or the central cluster down location, i.e., location no. 4, or the rear-view mirror, i.e., location no. 5, or the passenger screen, i.e., location no. 6, or even somewhere else outside any of these pre-defined locations. The eye-gaze recognition module (410) generates a recognized eye-gaze characteristic (415) with information of the specific eye-gaze location.

The static eyes-off-road time assessment module (420) determines a static eyes-off-road time allowance (425) based on the recognized eye-gaze characteristic (415), regarding where the eye-gaze location is, how long the eyes-off-road time should be allowed for the driver under the detected situation.

It should be understood, while FIG. 3 uses specific locations of the in-cabin objects for the static eyes-off-road time module (400) to determine the static eyes-off-road time allowance (425), other factors that are specific to the individual locations can also play a role in the estimation, such as size of the location, brightness, display complexity, etc.

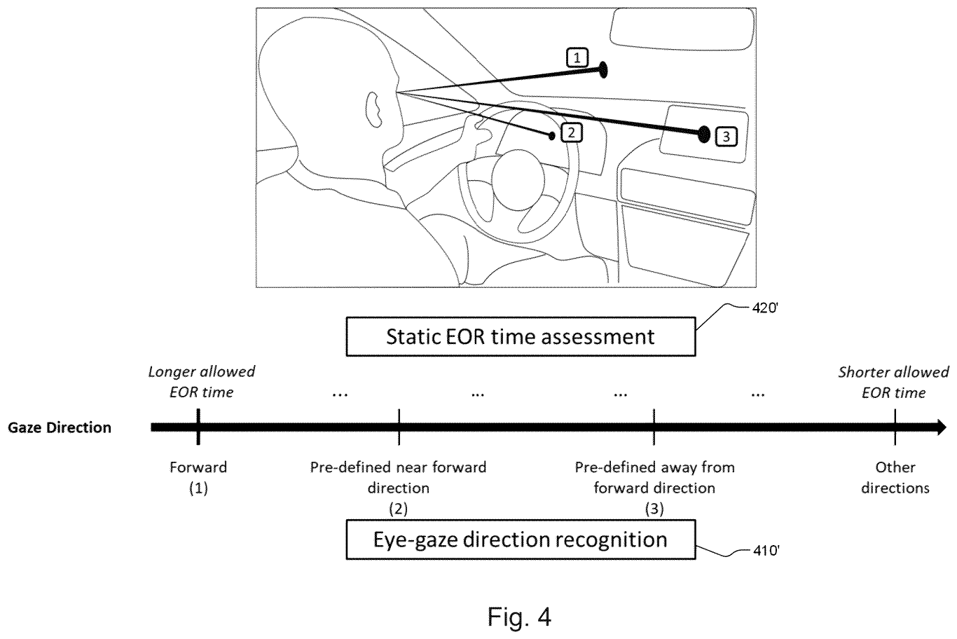

Likewise, driver's eye gaze can also be characterized based on the direction of the eye gaze, as illustrated in FIG. 4. The illustration here gives an example showing how the allowed eyes-off-road time can be adjusted based on the predefined direction where the driver is looking at. In this example, the eye-gaze recognition module (410) analyzes the driver's eye-gaze information (112) and resolves the precise eye-gaze direction in order to determine a static eyes-off-road time allowance for the driver.

In FIG. 4 the eye-gaze recognition module (410) can determine whether the driver's eye gaze is looking at the forward direction, i.e., direction no. 1, or a pre-defined near forward direction, i.e., direction no. 2, or a pre-defined away from forward direction, i.e., direction no. 3, or even somewhere else outside any of these pre-defined directions. The eye-gaze recognition module (410) generates a recognized eye-gaze characteristic (415) with specific eye-gaze direction information.

The static eyes-off-road time assessment module (420) then determines a static eyes-off-road time allowance (425) based on the information of recognized eye-gaze characteristic (415), that is, the eye-gaze direction. This static eyes-off-road time specifies the duration of the eyes-off-road time to be allowed for the driver under the detected situation.

The application of these principles described above based on driver's eye-gaze detection may depend on the resolution of the driver monitor system. If the DMS can only distinguish between the on- and off-road states of driver's eye-gaze, then the static eyes-off-road time allowance can be one predefined number which covers the whole “off-road” scenario. This number will then be modulated by the dynamic eyes-off-road adjustment factor as explained in this disclosure.

In addition to the static eyes-off-road time allowance determined based on driver's eye gaze, the eyes-off-road driving assistance system (200) also provides a dynamic adjustment of the eyes-off-road time based on dynamic factors. Information of the dynamic factors may be acquired from the on-board HMI module, or via vehicle-to-infrastructure communication of any sort including data stored in a cloud-based information system communicated through the HMI module or otherwise. The consideration of the various dynamic factors may result in extension or shortening of the permitted eyes-off-road time preliminarily determined by the static eyes-off-road module based on the actual dynamic situations the autonomous driving vehicle is operating on.

It is the intention of the present invention to dynamically adjust the time that a driver is allowed to look away from the road based on various factors. These factors may include but are not limited to the following: (a) Traffic factor, (b) Road factor, (c) Environmental factor, (d) Vehicle factor and (e) Driver factor.

Example of the Environmental factors to be considered for processing the dynamic eyes-off-road factor may include the various states of weather condition such as no precipitation, with rain, snow, fog or ice, or wind, etc. Better environmental conditions translate to longer allowed eyes-off-road time allowance, whereas poorer environmental conditions translate to shorter allowed eyes-off-road time allowance.

Example of Traffic factors to be considered for processing the dynamic eyes-off-road factor may include the various states of traffic condition. For example, dense traffic translates to shorter allowed eyes-off-road time, whereas light traffic translates to longer allowed eyes-off-road time. On the other hand, if the vehicle is in a stop-and-go traffic, the allowed eyes-off-road time can be adjusted based on the movement of the lead vehicle. Finally, if the vehicle is located at a traffic light, the allowed eyes-off-road time can be adjusted based on the duration of the red-light signal.

Example of Vehicle factors to be considered for processing the dynamic eyes-off-road factor may include the various states of vehicle operating condition. For example, if there exist any issues with the vehicle that do not prevent the AD/ADAS systems from operating but deserve driver's attention, allowed eyes-off-road time can also be adjusted. Additional factors to be considered may include tire inflation, headlights failure, etc.

Example of Road factors to be considered for processing the dynamic eyes-off-road factor may include the various states of road condition. For example, straight roads with several lanes going into the same direction translate into longer allowed eyes-off-road time, whereas curvy, narrow roads translate into shorter allowed eyes-off-road time.

Example of Driver's factors to be considered for processing the dynamic eyes-off-road factor may include the various states of driver condition. For example, signs of driver's sleepiness or any kind of impairment can be used to adjust the allowed eyes-off-road time such that higher impairment translates into shorter and lower impairment translates into longer allowed eyes-off-road time.

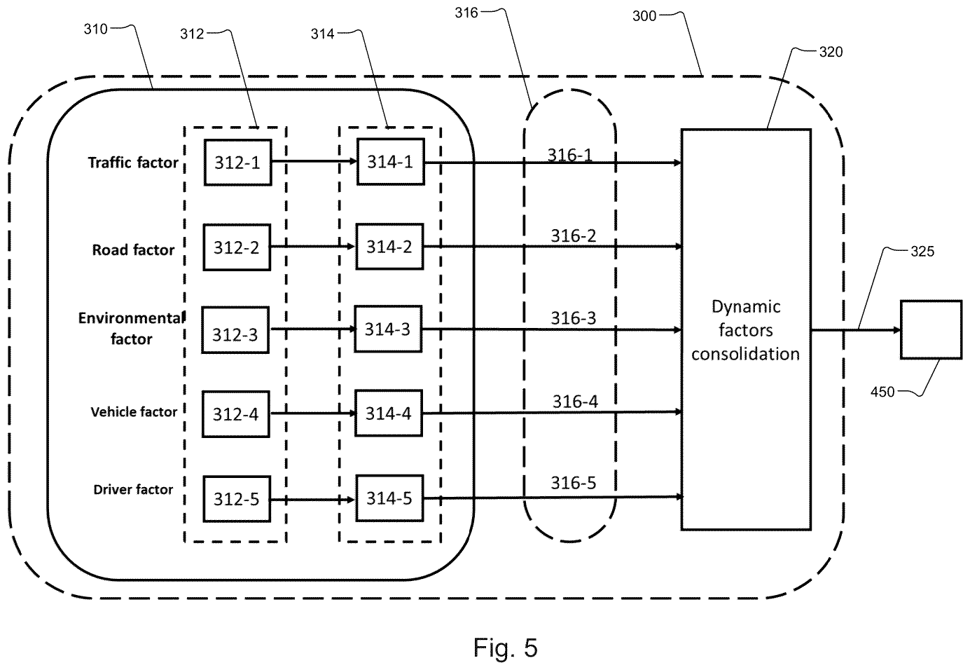

The above-mentioned dynamic factors are to be processed by the dynamic eyes-off-road factor process module (300), of which a block diagram is shown in FIG. 5. The dynamic eyes-off-road factor process module (300) includes a dynamic eyes-off-road factor analysis module (310) and a dynamic eyes-off-road factors consolidation module (320). The dynamic eyes-off-road factor analysis module (310) generates dynamic eyes-off-road time factor assessment (316) and sends the dynamic eyes-off-road time factor assessment (316) to the dynamic eyes-off-road factors consolidation module (320) via electrical communication. The dynamic eyes-off-road factors consolidation module (320) generates the dynamic eyes-off-road time adjustment factor (325) and sends the dynamic eyes-off-road time adjustment factor (325) to the eyes-off-road time adjustment module (450) via electrical communication.

The dynamic eyes-off-road factor analysis module (310) includes a dynamic factor recognition module (312) for recognizing the state of the various dynamic factors and a dynamic factor assessment module (314) for assessing an eyes-off-road adjustment factor based on the state of the recognized dynamic factor. Adjusting the allowed eyes-off-road time can be done on continuous scales which range between the extreme values of each factor. This way the effects of each factor can be taken into consideration individually.

The various dynamic eyes-off-road time factor assessments (316) corresponding to the various dynamic factors are collectively sent to the dynamic eyes-off-road factors consolidation module (320). In the dynamic eyes-off-road factors consolidation module (320) the various dynamic factors are considered together to form a consolidated dynamic eyes-off-road time adjustment factor (325). The process of the consolidation is described in a later paragraph in this disclosure.

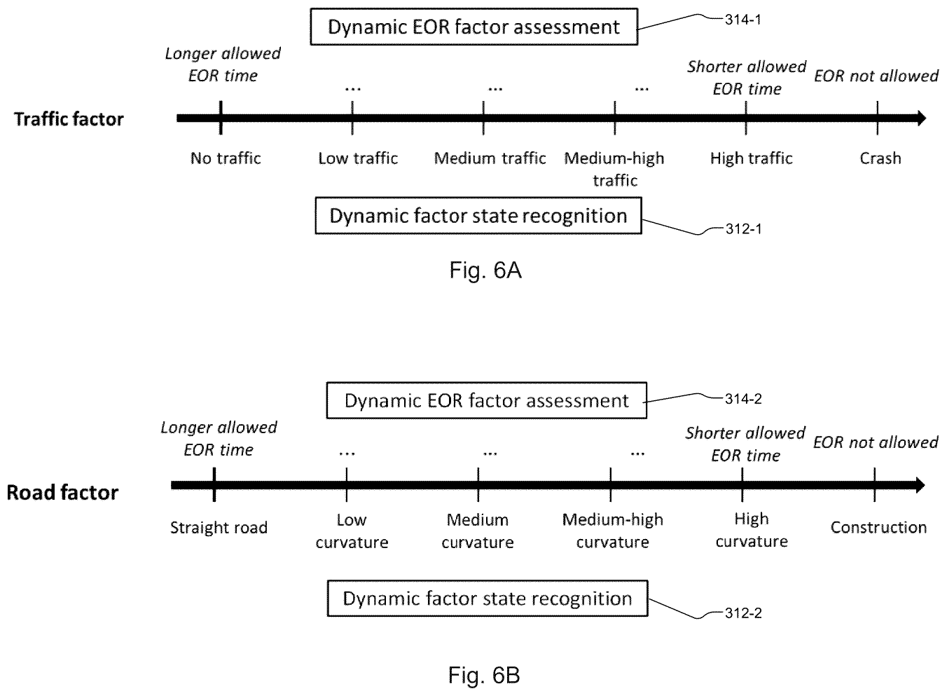

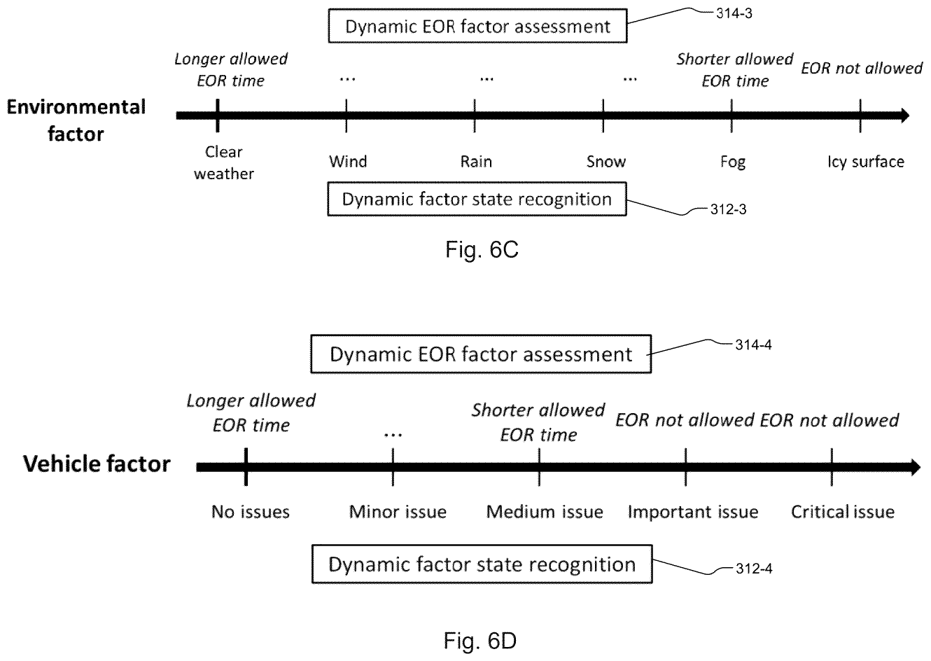

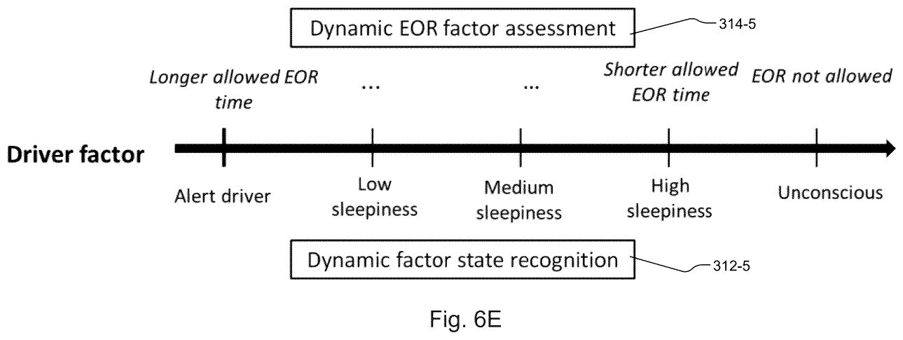

FIG. 6A, FIG. 6B, FIG. 6C, FIG. 6D and FIG. 6E collectively show an illustration demonstrating how the dynamic factor recognition module (312) and dynamic factor assessment module (314) process the various dynamic factors regarding the eyes-off-road adjustment factor. For each of the dynamic factors, for example, in FIG. 6A, the Traffic factor, the state, which may be one of “No traffic”, “Low traffic”, “Medium traffic”, “Medium-high traffic”, “High traffic” or “Crash”, is recognized by the dynamic factor recognition module (312), the dynamic factor assessment module (314) then determines a dynamic eyes-off-road time factor assessment (316), which ranges from “Longer allowed EOR time” to “Shorter allowed EOR time” or even “EOR not allowed”, based on the recognized state of the dynamic factor. Similarly, additional dynamic factors such as Road factor, Environmental factor, Vehicle factor and Driver factor may be processed the same way as illustrated in FIG. 6B, FIG. 6C, FIG. 6D and FIG. 6E, respectively.

In a preferred embodiment of this invention, the dynamic eyes-off-road time factor assessment (316) is assigned a number of unitless scaler to be used as a weight to be multiplied to the static eyes-off-road time allowance for the eyes-off-road time adjustment. The smaller such weight is, the stronger negative effect a factor has on the eyes-off-road time allowance resulting in more reduction of the permitted eyes-off-road time from a preliminarily determined static value. The values of each factor are then multiplied together in the dynamic eyes-off-road factors consolidation module (320), which represents their interactions, to get the overall dynamic eyes-off-road time adjustment (325). This overall dynamic eyes-off-road time adjustment (325) is then sent to the eyes-off-road time adjustment module (450) to be multiplied with the static eyes-off-road time allowance, which is based on the predetermined allowed eyes-off-road time for each gaze characteristic of interest.

In one embodiment of the above-described dynamic eyes-off-road factor analysis module (310) such eye-gaze characteristic may be an eye-gaze location, yet in another embodiment such eye-gaze characteristic may be an eye-gaze direction. In this approach the static eyes-off-road time allowance may be defined to range between some predefined large value, for example, Eyes-Off-Road_Max, to some predefined small value, for example, Eyes-Off-Road_Min. Resultantly the effect of the dynamic eyes-off-road time adjustment is to “modulate” the allowed eyes-off-road time for each eye-gaze location or eye-gaze direction as in the respective embodiment may be.

Examples of the dynamic eyes-off-road adjustment factors are illustrated in the tables below:

| | Clear | Wind | Rain | Snow | Fog | Icy |
|---|---|---|---|---|---|---|
| Environmental | 1 | 0.8 | 0.6 | 0.4 | 0.2 | 0 |
| factor (Ef) | | | | | | |
| | no limit | | | | | eyes-off-road |
| | | | | | | not allowed |

| | No traffic | Low | Medium | Busy | High | Crash |
|---|---|---|---|---|---|---|
| Traffic | 1 | 1 | 0.8 | 0.5 | 0.3 | 0 |
| factor (Tf) | | | | | | |
| | no limit | | | | | eyes-off-road not |
| | | | | | | allowed |

| | No | | | | | |
|---|---|---|---|---|---|---|
| | curvature | Low | Medium | Sharp | High | Construction |
| Road | 1 | 1 | 0.8 | 0.5 | 0.3 | 0 |
| factor (Rf) | | | | | | |
| | no limit | | | | | eyes-off-road |
| | | | | | | not allowed |

| | No issues | Minor issue | Medium issue | Serious issue |
|---|---|---|---|---|
| Vehicle | 1 | 1 | 0.5 | 0 |
| factor (Vf) | no limit | | | eyes-off-road |
| | | | | not allowed |

| | | Low | Medium | High | |
|---|---|---|---|---|---|
| | Alert | sleepiness | sleepiness | sleepiness | Unconscious |
| Driver | 1 | 0.6 | 0.3 | 0 | 0 |
| factor (Df) | no | | | eyes-off-road | eyes-off-road |
| | limit | | | not allowed | not allowed |

An example of static eyes-off-road time allowance is illustrated in the table below:

| | | | | Central | | |
|---|---|---|---|---|---|---|
| | Instrument | Steering | Central | cluster | Passenger | Elsewhere |
| Gaze location | panel | wheel | cluster up | down | screen | in cabin |
| Static eyes-off- | Eyes-off- | Eyes-off- | Eyes-off- | X | Y | Eyes-off- |
| road time | road_Max | road_Max | road_Max | | | road_Min |
| assessment | | | | | | |
| (Static_eyes-off- | | | | | | |
| road_time) | | | | | | |

Based on the above example, the resultant eyes-off-road time permitted for the driver, Total_eyes-off-road_time, is determined

Total_eyes-off-road_time=Static_eyes-off-road_time*Ef*Tf*Rf*Vf*Df

In a second embodiment of dynamic eyes-off-road factor analysis module (310), the dynamic eyes-off-road time factor assessment (316) is assigned a number representing a duration of time to be added to the static eyes-off-road time allowance for the eyes-off-road time adjustment. The larger each number is, the stronger positive effect a factor has on the eyes-off-road time allowance in extending the permitted eyes-off-road time from a preliminarily determined static value.

The number of the dynamic eyes-off-road time factor assessment (316) may also be a negative number for the purpose of reducing the eyes-off-road time allowance from the preliminarily determined static eyes-off-road time. The more negative number is the more effect on the eyes-off-road time reduction.

The values of each factor are then added together in the dynamic eyes-off-road factors consolidation module (320) subject to an upper bound and a lower bound limitation, which represents their interactions, to get the overall dynamic eyes-off-road time adjustment (325). This overall dynamic eyes-off-road time adjustment (325) is then sent to the eyes-off-road time adjustment module (450) to be added with the static eyes-off-road time allowance, which is based on the predetermined allowed eyes-off-road time for each gaze location or direction.

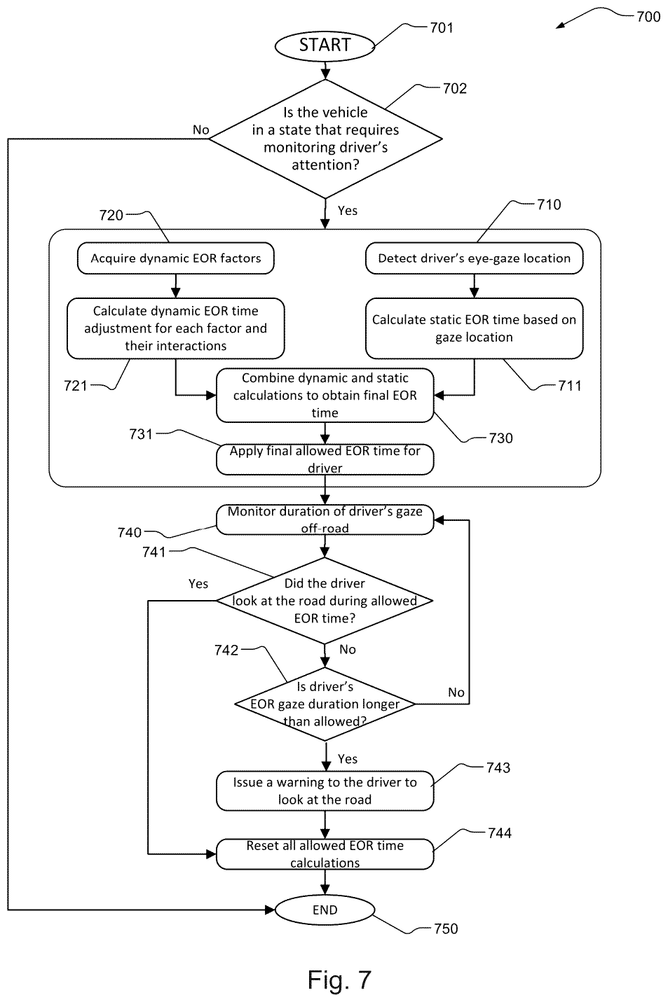

Referring now to FIG. 7 a flow diagram of operating the eyes-off-road driving assistance system (700) is shown. The diagram shows the method of a process that may be used to derive the final allowed eyes-off-road time. This process is executed in an autonomous driving vehicle controller for each control cycle. The process starts at Step 701.

In Step 702, the process determines whether the vehicle is in a state that requires monitoring the driver's attention. If the answer is No, the process is directed to Step 750 and exits the process for the control cycle. If the answer is Yes, the process proceeds to execute Step 710 and Step 720 and the respective subsequent steps.

In Step 710 the process detects driver's eye-gaze location, followed by Step 711 to calculate the static eyes-off-road time based on eye-gaze location. It should be noted that the process may also detect driver's eye-gaze direction in Step 710 and calculates the static eyes-off-road time based on the eye-gaze direction.

In Step 720 the process acquires the dynamic eyes-off-road factors followed by Step 721 to calculate the dynamic eyes-off-road time adjustment for each factor and their interactions.

Both Step 711 and Step 721 are directed to Step 730 where the process combines the dynamic and static calculations to obtain final eyes-off-road time allowance followed by Step 731 to apply final allowed eyes-off-road time for the driver.

In Step 740 the process monitors the duration of driver's gaze off-road, then proceeds to Step 741 to examine whether the driver looks at the road during allowed eyes-off-road time. If the answer is Yes then the process is directed to Step 744 to reset all allowed eyes-off-road time calculations, then proceeds to Step 750.

If the answer is No then the process further proceeds to Step 742 to inquire whether the driver's eyes-off-road gaze duration is longer than allowed. If the answer is No then the process is directed back to Step 740 to continue monitoring the driver's eye gaze; otherwise the process is directed to Step 743 to issue a warning to the driver for the driver to look at the road.

After issuing the warning to the driver, the process resets all allowed eyes-off-road time calculations at Step 744 and proceed to the end of the control cycle.

The broad teachings of the disclosure can be implemented in a variety of forms. Therefore, while this disclosure includes particular examples, the true scope of the disclosure should not be so limited since other modifications will become apparent to the skilled practitioner upon a study of the drawings, the specification, and the following claims.

What is claimed is:

1. An eyes-off-road driving assistance system for an automatic driving vehicle equipped with a sensor system comprising plurality of sensors for sensing the driving environment wherein the vehicle is operating autonomously, a driver monitor system providing driver eye-gaze information of a driver, a driver warning system providing warning signals to the driver and an autonomous driving human-machine interface (HMI) system comprising an eyes-off-road time monitor that monitors a time that driver's eye gaze is off the road and a dynamic factor acquisition module that acquires a plurality of dynamic factors information from vehicle and driver during the autonomous driving, said eyes-off-road driving assistance system comprising:
a static eyes-off-road time module characterized by generating a static eyes-off-road time for the driver allowing driver's eye gaze to be away from the road in front of the autonomous driving vehicle,
a dynamic eyes-off-road factor process module characterized by generating a dynamic eyes-off-road adjustment factor,
an eyes-off-road time adjustment module characterized by making adjustment on the static eyes-off-road time for the driver based on the dynamic eyes-off-road adjustment factor and generating an allowed eyes-off-road time for the driver,
wherein:
the static eyes-off-road time module is in electrical communication with the driver monitor system and receives driver's eye gaze information from the driver monitor system, the static eyes-off-road time module generates the static eyes-off-road time information based on the driver's eye gaze information, and the static eyes-off-road time module is also in electrical communication with the eyes-off-road time adjustment module and sends the static eyes-off-road time information to the eyes-off-road adjustment module,
the dynamic eyes-off-road factor process module is in electric communication with the dynamic factor acquisition module and receives the plurality of dynamic factor information from the vehicle and the driver during the autonomous driving, the dynamic eyes-off-road factor process module generates the dynamic eyes-off-road adjustment factor based on the plurality of dynamic factor information, and the dynamic eyes-off-road factor process module is also in electrical communication with the eyes-off-road time adjustment module and sends the dynamic eyes-off-road adjustment factor to the eyes-off-road time adjustment module, and
the eyes-off-road time adjustment module is in electrical communication with the static eyes-off-road time module and the dynamic eyes-off-road factor process module to receive the static eyes-off-road time information and the dynamic eyes-off-road adjustment factor, the eyes-off-road time adjustment module is also in electrical communication with the eyes-off-road time monitor of the autonomous driving HMI system and sends the allowed eyes-off-road time information to the eyes-off-road time monitor.

2. The eyes-off-road driving assistance system as in claim 1 wherein the static eyes-off-road time module further comprises an eye-gaze recognition module and a static eyes-off-road time assessment module,
wherein:
the eye-gaze recognition module is characterized by recognizing a state of eye-gaze detected by the driver monitor system, and
the static eyes-off-road time assessment module is characterized by determining the static eyes-off-road time for the driver based on the state of eye-gaze.

3. The eyes-off-road driving assistance system as in claim 2 wherein the state of eye-gaze is characterized by location.

4. The eyes-off-road driving assistance system as in claim 2 wherein the state of eye-gaze is characterized by direction.

5. The eyes-off-road driving assistance system as in claim 1 wherein the eyes-off-road time adjustment module generates the allowed eyes-off-road time from the static eyes-off-road time and the dynamic eyes-off-road adjustment factor by multiplying the dynamic eyes-off-road adjustment factor to the static eyes-off-road time.

6. The eyes-off-road driving assistance system as in claim 1 wherein the eyes-off-road time adjustment module generates the allowed eyes-off-road time from the static eyes-off-road time and the dynamic eyes-off-road adjustment factor by adding the dynamic eyes-off-road adjustment factor to the static eyes-off-road time.

7. The eyes-off-road driving assistance system as in claim 5 wherein the dynamic eyes-off-road factor process module further comprises a dynamic eyes-off-road factor analysis module and a dynamic eyes-off-road factors consolidation module,
wherein:
the dynamic eyes-off-road factor analysis module further comprises:
a dynamic factor recognition module in electrical communication with the dynamic factor acquisition module and characterized by recognizing a state of one of the plurality of the dynamic factors acquired by the dynamic factor acquisition module, and
a dynamic factor assessment module in electrical communication with the dynamic factor recognition module and characterized by assessing a dynamic eyes-off-road time factor based on the state of the dynamic factor wherein the dynamic eyes-off-road time factor is assigned a time factor value ranging from a predetermined lower limit to a predetermined upper limit, said dynamic factor assessment module is further in electrical communication with the dynamic eyes-off-road factors consolidation module and sends the dynamic eyes-off-road time factor assessment to the dynamic eyes-off-road factors consolidation module.

8. The eyes-off-road driving assistance system as in claim 7 wherein the time factor value is a unitless scaler with the lower limit being zero and the upper limit being greater than or equal to 1.

9. The eyes-off-road driving assistance system as in claim 8 wherein the plurality of dynamic factors comprises a traffic factor, of which the state comprises one of “No traffic”, “Low traffic”, “Medium traffic”, “Medium-high traffic”, “High traffic” and “Crash” by order of such listing sequence herein, wherein the dynamic factor assessment module assesses the dynamic eyes-off-road time factor with a higher value for the state listed in the earlier order of the sequence and a lower value for the state listed in the later order of this sequence.

10. The eyes-off-road driving assistance system as in claim 8 wherein the plurality of dynamic factors comprises a road factor, of which the state comprises one of “Straight road”, “Low curvature”, “Medium curvature”, “Medium-high curvature”, “High curvature” and “Construction” by order of such listing sequence herein, wherein the dynamic factor assessment module assesses the dynamic eyes-off-road time factor with a higher value for the state listed in the earlier order of the sequence and a lower value for the state listed in the later order of this sequence.

11. The eyes-off-road driving assistance system as in claim 8 wherein the plurality of dynamic factors comprises an environmental factor, of which the state comprises one of “Clear weather”, “Wind”, “Rain”, “Snow”, “Fog” and “Icy surface” by order of such listing sequence herein, wherein the dynamic factor assessment module assesses the dynamic eyes-off-road time factor with a higher value for the state listed in the earlier order of the sequence and a lower value for the state listed in the later order of this sequence.

12. The eyes-off-road driving assistance system as in claim 8 wherein the plurality of dynamic factors comprises a vehicle factor, of which the state comprises one of “No issues”, “Minor issue”, “Medium issue”, “Important issue” and “Critical issue” by order of such listing sequence herein, wherein the dynamic factor assessment module assesses the dynamic eyes-off-road time factor with a higher value for the state listed in the earlier order of the sequence and a lower value for the state listed in the later order of this sequence.

13. The eyes-off-road driving assistance system as in claim 8 wherein the plurality of dynamic factors comprises a driver factor, of which the state comprises one of “Alert driver”, “Low sleepiness”, “Medium sleepiness”, “High sleepiness” and “Unconscious” by order of such listing sequence herein, wherein the dynamic factor assessment module assesses the dynamic eyes-off-road time factor with a higher value for the state listed in the earlier order of the sequence and a lower value for the state listed in the later order of this sequence.

14. The eyes-off-road driving assistance system as in claim 6 wherein the dynamic eyes-off-road factor process module further comprises a dynamic eyes-off-road factor analysis module and a dynamic eyes-off-road factors consolidation module,
wherein:
the dynamic eyes-off-road factor analysis module further comprises:
a dynamic factor recognition module in electrical communication with the dynamic factor acquisition module and characterized by recognizing a state of one of the plurality of the dynamic factors acquired by the dynamic factor acquisition module, and
a dynamic factor assessment module in electrical communication with the dynamic factor recognition module and characterized by assessing a dynamic eyes-off-road time factor based on the state of the dynamic factor wherein the dynamic eyes-off-road time factor is assigned a time factor value ranging from a predetermined upper limit to a predetermined lower limit, said dynamic factor assessment module is further in electrical communication with the dynamic eyes-off-road factors consolidation module and sends the dynamic eyes-off-road time factor assessment to the dynamic eyes-off-road factors consolidation module.

15. The eyes-off-road driving assistance system as in claim 14 wherein the time factor value has a unit of time with the lower limit being a negative number.

16. The eyes-off-road driving assistance system as in claim 15 wherein the plurality of dynamic factors comprises a traffic factor, of which the state comprises one of “No traffic”, “Low traffic”, “Medium traffic”, “Medium-high traffic”, “High traffic” and “Crash” by order of such listing sequence herein, wherein the dynamic factor assessment module assesses the dynamic eyes-off-road time factor with a higher value for the state listed in the earlier order of the sequence and a lower value for the state listed in the later order of this sequence.

17. The eyes-off-road driving assistance system as in claim 15 wherein the plurality of dynamic factors comprises a road factor, of which the state comprises one of “Straight road”, “Low curvature”, “Medium curvature”, “Medium-high curvature”, “High curvature” and “Construction” by order of such listing sequence herein, wherein the dynamic factor assessment module assesses the dynamic eyes-off-road time factor with a higher value for the state listed in the earlier order of the sequence and a lower value for the state listed in the later order of this sequence.

18. The eyes-off-road driving assistance system as in claim 15 wherein the plurality of dynamic factors comprises an environmental factor, of which the state comprises one of “Clear weather”, “Wind”, “Rain”, “Snow”, “Fog” and “Icy surface” by order of such listing sequence herein, wherein the dynamic factor assessment module assesses the dynamic eyes-off-road time factor with a higher value for the state listed in the earlier order of the sequence and a lower value for the state listed in the later order of this sequence.

19. The eyes-off-road driving assistance system as in claim 15 wherein the plurality of dynamic factors comprises a vehicle factor, of which the state comprises one of “No issues”, “Minor issue”, “Medium issue”, “Important issue” and “Critical issue” by order of such listing sequence herein, wherein the dynamic factor assessment module assesses the dynamic eyes-off-road time factor with a higher value for the state listed in the earlier order of the sequence and a lower value for the state listed in the later order of this sequence.

20. The eyes-off-road driving assistance system as in claim 15 wherein the plurality of dynamic factors comprises a driver factor, of which the state comprises one of “Alert driver”, “Low sleepiness”, “Medium sleepiness”, “High sleepiness” and “Unconscious” by order of such listing sequence herein, wherein the dynamic factor assessment module assesses the dynamic eyes-off-road time factor with a higher value for the state listed in the earlier order of the sequence and a lower value for the state listed in the later order of this sequence.

21. A method for operating the eyes-off-road driving assistance system as in claim 1 comprising steps of
determining whether the vehicle is in a state that requires monitoring driver's attention,
acquiring dynamic eyes-off-road factors,
calculating dynamic eyes-off-road time adjustment for each factor,
detecting driver's eye-gaze location or eye-gaze direction,
calculating static eyes-off-road time based on the eye-gaze location or eye-gaze direction,
combining dynamic and static calculations to obtain final eyes-off-road time allowed for the driver,
monitoring duration of driver's eye gaze off-road,
determining whether the driver looks at the road during allowed eyes-off-road time,
determining whether the driver's eyes-off-road gaze duration is longer than allowed eyes-off-road time, and
issuing warning to driver when the driver's eyes-off-road gaze duration is longer than allowed.
